(19) United States
(12) Patent Application Publication
(10) Pub. No.: US 2008/0273009 A1
(43) Pub. Date: Nov. 6, 2008

(54) Information Reproducing Apparatus and Method, Dj Device, and Computer Program

(75) Inventors: Katsuhiko Goda, Saitama (JP); Yoshiyuki Kakuta, Saitama (JP)

Correspondence Address: YOUNG & THOMPSON, 209 Madison Street, Suite 500, ALEXANDRIA, VA, 22314, US

(73) Assignee: Pioneer Corporation, Tokyo (JP)

(21) Appl. No.: 11/910,084

(22) PCT Filed: Mar. 27, 2006
(86) PCT No.: PCT/JP2006/306181

§ 371 Date: Jan. 3, 2008

(30) Foreign Application Priority Data
Mar. 28, 2005 (JP) 2005-091915

(51) Int. Cl. G09G 5/00

(52) U.S. Cl. 345/156

(57) ABSTRACT

An information reproducing apparatus (1) is provided with: a reproducing device (ii) for reproducing content data; an operating device (41) which is movable by an operation of a user and which is used in realizing each of a first function and a second function, the first function being for adding a predetermined effect to the reproduction of the content data, the second function being for specifying a start position for start the reproduction of the content data from an arbitrary position; a changing device (43) for changing whether to realize the first function or the second, function on the, operating device; and a reproduction controlling device (20) for making the reproducing device reproduce the content data from the start position specified by the operating device.

### TECHNICAL FIELD

The present invention relates to DJ equipment and an information reproducing apparatus and method which reproduce audio information and/or video information recorded on a recording medium, and a computer program used for the information reproducing apparatus.

### BACKGROUND ART

Recently, there has been spread of a recording medium which allows data recording and data reproduction by using a digital signal, such as a CD and a DVD, Along with that, an information reproducing apparatus, which performs a unique reproduction process due to the digital signal, is also under development. For example, a CD and a DVD have a series of video scenes or music (i.e. content data) recorded in association with each other. For example, in case of a movie, each video scene having a predetermined reproduction time length is recorded as a plurality of data groups such that the video scene is reproduced in accordance with a series of reproduction sequence specified by a PGC (Program Group Chain) or play list. For example, in case of music, each music or song having a predetermined reproduction time length is recorded as a plurality of data groups distinguished by track numbers. Thus, the information reproducing apparatus can perform cue-reproduction for searching for and reproducing a head address of each video scene or music, random-reproduction for arbitrarily changing the reproduction order of each video scene or music, or the like.

On the other hand, an information reproducing apparatus for detecting and displaying a beat density of the content data has been also developed (refer to patent documents 1 and 2). Detecting and displaying the beat density enable a user to understand characteristics of the content data relatively easily, to thereby facilitate the user's specification of a desired reproduction position.

Patent document 1: Japanese Patent Application Laid Open NO. 2002-341888
Patent document 2: Japanese Patent Application Laid Open NO, 2002-352569

### DISCLOSURE OF INVENTION

### Subject to be Solved by the Invention

This type of conventional information reproducing apparatus, however, has such a problem that the user's desired reproduction position in the content data cannot be preferably specified. That is, the aforementioned information reproducing apparatus has such a problem that it is necessary to specify the reproduction position by operating independent and normal operation buttons (e.g. a fast-forward button, a rewinding button, or the like, which independently exist), so that the reproduction position cannot be preferably specified quickly.

The subject to be solved by the invention includes the aforementioned problem as one example. It is therefore an object of the present invention to provide DJ equipment and an information reproducing apparatus and method which enable quick specification of the user's desired reproduction position in the content data, and a computer program which runs a computer as the information reproducing apparatus.

### Means for Solving the Subject

(Information Reproducing Apparatus)

The above object of the present invention can be achieved by an information reproducing apparatus provided with: a reproducing device for reproducing content data; an operating device which is movable by an operation of a user and which is used in realizing each of a first function and a second function, the first function being for adding a predetermined effect to the reproduction of the content data, the second function being for specifying a start position for start the reproduction of the content data from an arbitrary position; a changing device for changing whether to realize the first function or the second function on the operating device; and a reproduction controlling device for making the reproducing device reproduce the content data from the start position specified by the operating device.

According to the information reproducing apparatus of the present invention, the content data including video images, audio, or the like can be reproduced by the operation of the reproducing device.

When the content data is reproduced, the user of the information reproducing apparatus can perform operations by using the operating device. Specifically, the user operates the operating device (for example, the user directly touches it to operate), by which the predetermined effect can be added (i.e. the first function can be realized) to the reproduction of the content data. Alternatively, the start position for starting the reproduction of the content data from the arbitrary position can be specified (i.e. the second function can be realized). Whether the user's operation by using the operating device is an operation to realize the first function or the second function is changed by the changing device. If the operation of the operating device is set to be the operation to realize the first function by the operation of the changing device, the user can add the predetermined effect to the reproduction of the content data by operating the operating device. On the other hand, if the operation of the operating device is set to be the operation to realize the second function by the operation of the changing device, the user can specify the start position for starting the reproduction of the content data from the arbitrary position by operating the operating device. Once the start position is specified to start the reproduction of the content data from the arbitrary position, the reproduction of the content data is started from the specified start position by the operation of the reproduction controlling device.

As described above, according to the information reproducing apparatus of the present invention, the content data can be reproduced from the arbitrary reproduction position by using the operating device. As a result, the user can specify the reproduction position preferably, by using the operating device for adding the effect. By this, the user can specify the desired reproduction position in the content data, preferably (e.g. quickly).

In addition, the operating device can also realize the second function for specifying the reproduction position, in addition to the first function for adding various effects to the content data. That is, in order to realize the two functions, the information reproducing apparatus only needs to be provided with one operating device. Therefore, there are such advantages that the configuration of the information reproducing apparatus can be made relatively simple and that the user's operability can be improved.

In one aspect of the information reproducing apparatus of the present invention, the reproduction controlling device makes the reproducing device reproduce the content data from the start position specified by the operating device after the operation of the operating device by the user is ended.

According to this aspect, if the user ends the operation by the operating device, automatically, the reproduction of the content data is started from the specified start position. Therefore, the user does not have to give an instruction again to change the operation of the operating device after the specification of the start position. Thus, it is possible to improve the user's operability.

In another aspect of the information reproducing apparatus of the present invention, it is further provided with a specifying device for specifying an operation mode of the content data after the operation of the operating device by the user is ended, the reproduction controlling device controlling the operation of the reproducing device in the operation mode specified by the specifying device.

According to this aspect, it is possible to control the operation of the reproducing device after the start position is specified by the user. For example, after the start position is specified by using the operating device, an operation mode to start the reproduction immediately or an operation mode to stand by in a pause can be specified. In this case, the deactivation of the pause (i.e. the start of the reproduction) may be performed by pressing any of the buttons or by some operation of the operating device, such as a jog dial. Moreover, the reproducing device may be controlled to operate in an operation mode to start the reproduction after a lapse of a certain time after the stand by in the pause. As described above, a variety of reproduction aspects can be realized.

In another aspect of the information reproducing apparatus of the present invention, it is further provided with a detecting device for detecting the end of the operation of the operating device by the user to realize the second function, the changing device performing automatic change such that the first function is realized on the operating device if the end of the operation of the operating device to realize the second function is detected by the detecting device.

According to this aspect, in the case that the operation of the operating device is changed to the operation to realize the second function, if the end of the operation of the operating device is detected, the operation of the operating device is automatically changed to the operation to realize the first function. Therefore, the user does not have to change the operation of the operating device again. More specifically, the user only needs to change the operation of the operating device by using the changing device when the second function is realized. This can reduce the user's operating load, and after the start position is specified, the effect can be added immediately to the content data reproduced from the start position Therefore, it is possible to improve the user's operability.

In another aspect of the information reproducing apparatus of the present invention, it is further provided with a displaying device for displaying reproduction-position information of the content data.

According to this aspect, the reproduction-position information about the reproduction position of the content data is displayed by the operation of the displaying device. More specifically, a reproduction time point, an elapsed time, a reproduction remaining time or the like of the content data which is a current reproduction target or a current reproduction position or the like on a reproduction time axis may be displayed as the reproduction-position information. Moreover, displaying the characteristics of contents which are reproduction targets, such as a sound level of the contents, allows the recognition of a characteristic position such as a peak position (or most exciting position) of the contents (e.g. music or a song) and a position in which a low tone is emphasized, and the characteristic position may be used for the position specification. These allow the user to specify the reproduction position by using the operating device after visually recognizing a change in the reproduction position due to the reproduction of the content data and characteristic information about contents in front and in rear of the specified reproduction position. This allows the user to specify the desired reproduction position in the content data as the start position, directly and intuitively.

According to the information reproducing apparatus of the present invention, the displaying device displays the reproduction-position information according to the operation of the operating device if the second function is realized on the operating device.

According to this aspect, the display of the displaying device can be changed in accordance with the operation of the operating device. Specifically, for example, it is possible to display the reproduction position at which the reproduction is currently performed by the operation of the operating device. At this time, if the user operates the operating device to specify the start position, the reproduction position is displayed in an earlier position or a later position in real time along with the operation of the operating device. This allows the user to visually recognize the reproduction position at which the reproduction is currently performed, more preferably.

In another aspect of the information reproducing apparatus of the present invention, the operating device rotates in accordance with the operation of the user.

According to this aspect, for example, a JOG dial attached to DJ (Disc Jockey) equipment or the like can be used as the aforementioned operating device. Thus, it is possible to improve the operation of the information reproducing apparatus of the present invention, more preferably.

Incidentally, the “DJ” in the present invention indicates an user which reproduces the content data in a broad sense including not only music but also video images or the like, by using a special technique.

(Information Reproducing Method)

The above object of the present invention can be also achieved by an information reproducing method in an information reproducing apparatus provided with: a reproducing device for reproducing content data; and an operating device which is movable by an operation of a user and which is used in realizing each of a first function and a second function, the first function being for adding a predetermined effect to the reproduction of the content data, the second function being for specifying a start position for start the reproduction of the content data from an arbitrary position) the information reproducing method provided with: a changing process of changing whether to realize the first function or the second function on the rotation operating device; and a reproduction controlling process of making the reproducing device reproduce the content data from the start position specified by the operating device.

According to the information reproducing method of the present invention, it is possible to receive the same benefits as those of the aforementioned information reproducing apparatus of the present invention.

Incidentally, in response to the aforementioned various aspects of the information reproducing apparatus of the present invention, the information reproducing method of the present invention can also employ various aspects.

(DJ Equipment)

The above object of the present invention can be also achieved by a DJ equipment provided with: a reproducing device for reproducing content data; an operating device which is movable by an operation of a user and which is used in realizing each of a first function and a second function, the first function being for adding a predetermined effect to the reproduction of the content data, the second function being for specifying a start position for start the reproduction of the content data from an arbitrary position; and a reproduction controlling device for making the reproducing device reproduce the content data from the start position specified by the operating device.

According to the DJ equipment of the present invention, as in the aforementioned information reproducing apparatus of the present invention, it is provided with the reproducing device, the operating device, and the reproduction controlling device. Therefore, as in the aforementioned information reproducing apparatus of the present invention, the user can specify a desired reproduction time point in the content data.

Incidentally, in response to the aforementioned various aspects of the information reproducing apparatus of the present invention, the DJ equipment of the present invention can also employ various aspects.

In one aspect of the DJ equipment of the present invention, it is further provided with a changing device for changing whether to realize the first function or the second function on the operating device.

According to this aspect, as in the aforementioned information reproducing apparatus of the present invention, it is possible to make the configuration of the information reproducing apparatus relatively simple and to improve the user's operability.

(Computer Program)

The above object of the present invention can be also achieved by a computer program for reproduction control to control a computer provided in the aforementioned information reproducing apparatus of the present invention (including its various aspects), the computer program making the computer function as at least one portion of the information reproducing apparatus.

According to each of the computer program of the present invention, the aforementioned information reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the aforementioned information reproducing apparatus of the present invention, the computer program of the present invention can also employ various aspects.

The above object of the present invention can be also achieved by a computer program product in a computer-readable medium for tangibly embodying a program of instructions executable by a computer provided in the aforementioned information reproducing apparatus of the present invention (including its various aspects), the computer program product making the computer function as at least one portion of the information reproducing apparatus.

According to the computer program product of the present invention, the aforementioned information reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information reproducing apparatus of the present invention.

These effects and other advantages of the present invention will become more apparent from the embodiment explained below.

As explained above, according to the information reproducing apparatus of the present invention, it is provided with the reproducing device, the operating device, the changing device, and the reproduction controlling device. According to the information reproducing method of the present invention, it is provided with the reproducing process, the operating process, the changing process, and the reproduction controlling process. Moreover, according to the DJ equipment of the present invention, it is provided with the reproducing device, the operating device, and the reproduction controlling device. Therefore, it is possible to specify the user's desired reproduction time point in the content data.

### BRIEF DESCRIPTION OF DRAWINGS

FIG. 1 is a block diagram conceptually showing the basic structure of an optical disc reproducing apparatus in an embodiment.

FIG. 2 is a block diagram detailing showing particularly an operation device and a display device of the optical disc reproducing apparatus in the embodiment.

FIG. 3 is a flowchart conceptually showing a flow of the operation of the optical disc reproducing apparatus in the embodiment (particularly, a flow of the operation related to quick search).

FIG. 4 are plan views conceptually showing a display aspect of the display device in quick search.

FIG. 5 is a block diagram conceptually showing the basic structure of an optical disc reproducing apparatus in a modified example.

FIG. 6 is a flowchart conceptually showing a flow of the operation of the optical disc reproducing apparatus in the modified example (particularly, a flow of the operation related to quick search).

### DESCRIPTION OF REFERENCE CODES

1 optical disc reproducing apparatus
10 optical pickup
11 RF amplifier
20 system controller
40 operation device
41 jog dial
42 angular velocity detection device
43 quick-search-mode-in-button
50 display device
51 playing address
52 pointer
61 mode specification button

### BEST MODE FOR CARRYING OUT THE INVENTION

Hereinafter, the best mode for carrying out the present invention will be explained in each embodiment in order with reference to the drawings. Incidentally, in the embodiment below, the information reproducing apparatus of the present invention is applied to an optical disc reproducing apparatus, such as a CD player and a DVD player, which has various reproduction functions represented by reproduction-speed control, tempo control, rewinding reproduction, or the like. Moreover, the optical disc reproducing apparatus in the embodiment explained blow is used as DV equipment used when music data or video data are continuously reproduced while various special effects (or effects) are added to the data at a dance place, such as a club and a disco.

(1) Basic Structure)

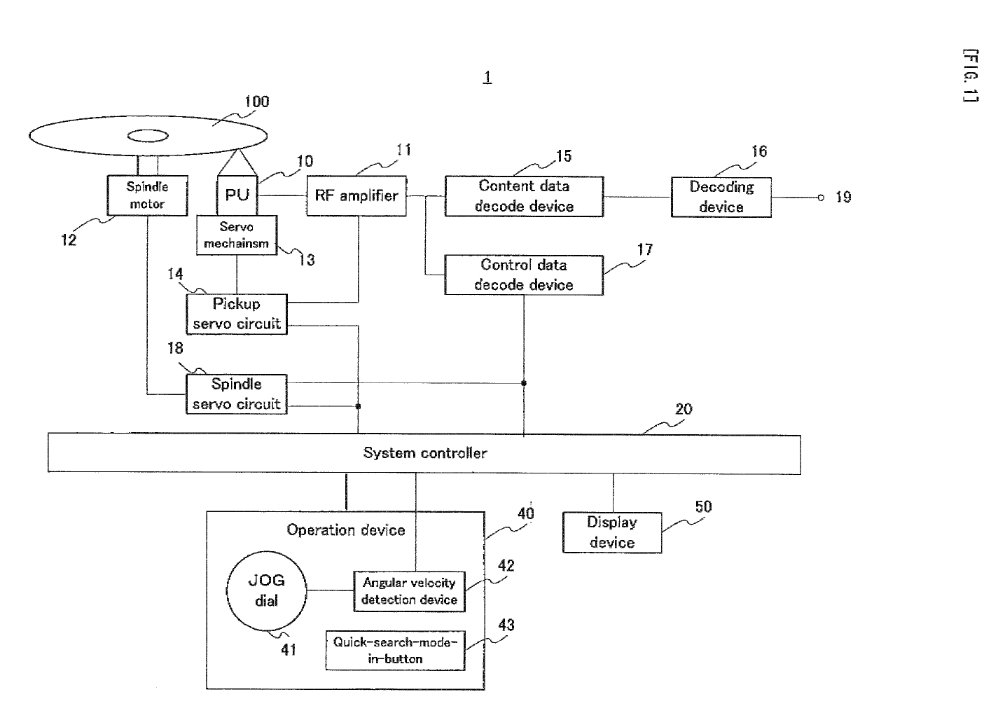

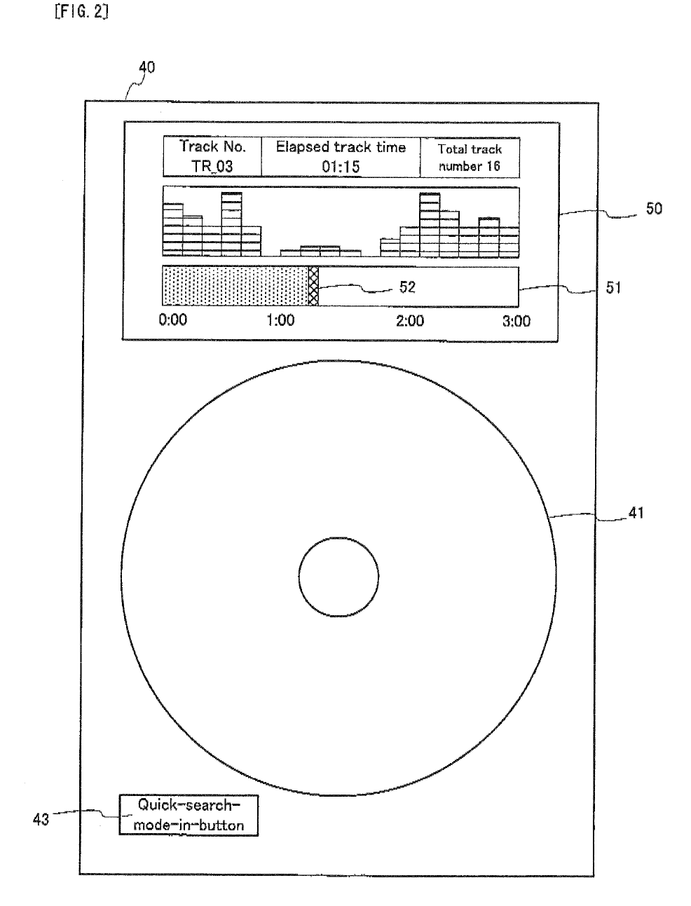

Firstly, with reference to FIG. 1 and FIG. 2, the basic structure of the optical disc reproducing apparatus in the embodiment will be explained. FIG. 1 is a block diagram conceptually showing the basic structure of an optical disc reproducing apparatus in an embodiment. FIG. 2 is a block diagram detailing showing particularly an operation device and a display device of the optical disc reproducing apparatus in the embodiment.

As shown in FIG. 1, an optical disc reproducing apparatus 1 is provided with: an optical pickup (PU) 10; a radio frequency (RF) amplifier 11; a spindle motor 12; a servo mechanism 13; a pickup servo circuit 14; a content-data decode device 15; a decoding device 16; a control-data decode device 17; a spindle servo circuit 18; an external output terminal 19; a system controller 20; an operation device 40; and a display device 50.

The optical pickup 10 is to read content data and control data from an optical disc 100 and is provided with a semiconductor laser apparatus, various lenses, an actuator, and the like. More specifically; the optical pickup 10 irradiates laser light LB onto the optical disc 100 with a predetermined power. The optical pickup 10 is also provided with a photo detector (PD) sensor for receiving reflected light of laser light LB from the optical disc 100 and outputs the received reflected light to the RF amplifier as a read signal.

The optical pickup 10 is adapted to be displaced in the radial direction or the like of the optical disc 100 in accordance with a tracking error signal, by a not-illustrated actuator; slider; or the like driven by the control of the servo mechanism 13. In addition, the optical pickup 10 is adapted to change the focal point of the laser light LB in accordance with a focus error signal, for the purpose of focus-control, by the control of the servo mechanism 13.

The RF amplifier 11 generates a RF signal on the basis of the read signal outputted from the optical pickup 10 and outputs the generated RF signal to each of the content-data decode device 15 and the control-data decode device 17. Moreover, the RF amplifier 11 generates an error signal, such as a focus error signal for controlling focus when the optical pickup 10 irradiates the optical disc 100 with the laser light LB and a tracking error signal for controlling tracking when the optical pickup 10 irradiates the optical disc 100 with the laser light LB, on the basis of the read signal outputted from the optical pickup 10. The generated error signal is outputted to the pickup servo circuit 14;

The spindle motor 12 is adapted to rotate the optical disc 100 at a predetermined speed under spindle servo by the spindle servo circuit 18.

The servo mechanism 13 displaces the optical pickup 10 in the radial direction of the optical disc 100 on the basis of a tracking servo control signal outputted from the pickup servo circuit 14. Moreover, the servo mechanism 13 displaces an objective lens included in the optical pickup 10, along the optical axis of the laser light LB, on the basis of a focus servo control signal outputted from the pickup servo circuit 14.

The pickup servo circuit 14 generates the focus servo control signal and the tracking servo control signal for controlling the servo mechanism 13, on the basis of the error signal outputted from the RF amplifier 11. The generated focus servo control signal and the generated tracking servo control signal are outputted to the servo mechanism 13. In other words, in order to prevent the occurrence of a focus error and a tracking error, the pickup servo circuit 14 feedback-controls the servo mechanism 13 on the basis of the error signal outputted from the RF amplifier 11.

The content-data decode device 15 decodes the RF signal outputted from the RF amplifier 11 to thereby generate a stream signal including a video stream and an audio stream. The generated stream signal is outputted to the decoding device 16.

The decoding device 16 decodes the stream signal outputted from the content-data decode device 15 to thereby generate a reproduction signal. The generated reproduction signal is outputted to external output equipment, such as a display and a speaker, through the external output terminal 19, and it is reproduced as video images and audio according to the content data recorded on the optical disc 100.

Incidentally, after a predetermined modulation process is performed with respect to the reproduction signal outputted from the decoding device 16, the modulated reproduction signal may be outputted to the external output equipment. More specifically, for example, modulation by a sawtooth wave may be performed with respect to the reproduction signal. For example, modulation by a rectangle wave may be performed with respect to the reproduction signal. For example, modulation which causes a Doppler effect may be performed with respect to the reproduction signal. For example, modulation by a special waveform imitating the sound of a jet plane may be performed with respect to the reproduction signal. For example, modulation by a special waveform imitating the sound of a gun may be performed with respect to the reproduction signal. For example, modulation by various special waveforms set by a user or the like in advance may be performed with respect to the reproduction signal. The modulation is preferably performed by that the user operates not-illustrated operation keys on the operation device 40.

The control-data decode device 17 decodes the RF signal outputted from the RF amplifier 11 to thereby generate the control data for controlling the reproduction of the content data. With regard to the control data, for example, TOC data or the like recorded in a lead-in area of the optical disc 100, synchronization data recorded with it included in the stream signal, sub-code data including time-passage information when the content data is reproduced, or the like are listed as one specific example thereof. The generated control data is outputted to the system controller 20 and is used to control the reproduction of the content data.

The spindle servo circuit 18 detects an error in the synchronization data with respect to the rotational speed of the spindle motor 12 instructed from the system controller 20, and it feedback-controls the rotation of the spindle motor 12 in order to inhibit the error occurrence.

Incidentally, a combination of the optical pickup 10, the RF amplifier 11, the content data decode device 15, and the decoding device 16 or the like described above constitutes one specific example of the “reproducing device” of the present invention.

The system controller 20 constitutes one specific example of the “reproduction controlling device” of the present invention and is provided with a micro processor (MPU). The system controller 20 executes a system program set in advance to thereby perform central control on the operation of the entire optical disc reproducing apparatus 1.

Moreover, the system controller 20 is connected to the operation device 40 and the display device 50. Instruction data from various operation keys provided for the operation device 40 is outputted to the system controller 20, and the system controller 20 controls the reproduction of the control data in accordance with the instruction data. Moreover, the system controller 20 controls the display operation of the display device 50.

The operation device 40 is provided with: a jog dial 41; an angular velocity detection device 42; and a quick-search-mode-in-button 43.

The jog dial 41 constitutes one specific example of the “operating device” of the present invention, and it is a disc-shaped operation key which can rotate in both directions. When the user or the like appropriately changes and operates the rotational direction and the rotational speed of the jog dial 41, forward reproduction and reverse reproduction can be set in accordance with the rotational direction, and moreover, the tone of a reproduction sound reproduced with a speaker and a head phone can be changed in accordance with the rotational speed.

Incidentally, the aforementioned forward reproduction means reproducing the content data on the optical disc 100 in recorded order, as in the case that an analog record such as an LP is rotated in a forward direction to thereby play music or the like. Therefore, music or the like is reproduced as a normal sound in accordance with the clockwise rotation of the jog dial 41. Moreover, even while the jog dial 41 is stopped, the forward reproduction can be performed.

On the other hand, the aforementioned reverse reproduction means reproducing the content data on the optical disc 100 in reverse order from the recorded order, as in the case that the analog record is rotated in the reverse direction to thereby play music or the like. Since music or the like is continuously recorded (or analog-recorded) on the analog record, rotating the analog record in the reverse direction causes the music or the like to be reproduced in the reverse direction, resulting in a reproduced imitation sound, which is different from the original music or the like. If the jog dial 41 is rotated in a counterclockwise direction, the individual content data which is digital-recorded on the optical disc 100 is reproduced in the reverse order. This causes the same imitation sound as in the case that the analog record is rotated and reproduced in the reverse direction.

As described above, because the same function that for reverse-reproducing the analog record is provided, if the user or the like repeats the quick reciprocating rotation of the jog dial 41 in the clockwise direction and in the counterclockwise direction, the imitation sound referred to as a so-called scratch sound (i.e. imitation sound such as “squeak” and “bang”) can be generated. Then, when a musical performer referred to as a disk jockey operates the jog dial 41 to generate the aforementioned scratch sound or the like, the disk jockey can perform editing for producing rap music or the like by using a CD and a DVD.

The angular velocity detection device 42 detects the rotational direction and the rotational speed (or angular velocity) of the jog dial 41. More specifically, the angular velocity detection device 42 is provided with a rotary encoder circuit, and it optically detects the rotational direction and the rotational speed of the jog dial 41. The detected rotational direction and the detected rotational speed of the jog dial 41 are outputted to the system controller 20. This allows the system controller 20 to recognize an operation amount of the jog dial 41 operated by the user or the like and to perform an effect operation according to the operation amount.

The quick-search-mode-in-button 43 constitutes one specific example of the “changing device” of the present invention, and it is pressed by the user when quick search is performed by using the jog dial 41. More specifically, if the quick-search-mode-in-button 43 is not pressed, the operation of the jog dial 41 is regarded as an instruction to perform the forward reproduction the reverse reproduction, and the scratch described above. On the other hand, if the quick-search-mode-in-button 43 is pressed, the operation of the jog dial 41 is regarded as an instruction to perform the quick search.

Incidentally, the “quick search” indicates an operation of specifying a start position for starting the reproduction of the content data from a desired position by operation the jog dial 41. For example, it is possible to specify, as the start position, a reproduction time (i.e. a reproduction position corresponding to the reproduction time) which is an elapsed time according to the rotational angle of the jog dial 41 in the same direction as a reproduction time axis of the content data i.e. in the future time), by rotating the jog dial 41 in the clockwise direction. On the other hand, it is possible to specify as the start position, a reproduction time (i.e. a reproduction position corresponding to the reproduction time) which goes back by a time according to the rotational angle of the jog dial 41 in the reverse direction from the reproduction time axis of the content data (i.e. in the past time), by rotating the jog dial 41 in the counterclockwise direction.

In particular, the elapsed amount of the reproduction position according to the rotational angle of the jog dial 41 in the quick search is set to be greater than that in the forward reproduction, the reverse reproduction or the like performed by the user's operation of the jog dial 41. Therefore, the quick search allows the content data to be reproduced from the desired position more quickly.

Incidentally, a correspondence relationship between the rotational angle of the jog dial 41 and the elapsed amount of the reproduction position may be determined in advance by using a predetermined table, function, or the like, in the manufacturing of the optical disc reproducing apparatus 1. Alternatively, the user may specify the correlation relationship, as occasion demands.

The display device 50 constitutes one specific example of the “displaying device” of the present invention and displays various information associated with the reproduction of the content data. The display device 50 is provided with a display panel, such as a liquid crystal display and a fluorescent tube, and displays the various information under the control of the system controller 20

FIG. 2 shows the more detailed appearance of the display device 50 (and further the operation device 40). As shown in FIG. 2, the display device 50 displays the various information according to the reproduction of the content data. For example, the display device 50 displays, in the upper part thereof a track number of the content data which is currently being reproduced, an elapsed time of the content data which is currently being reproduced (i.e. a current reproduction time), the total track number of the content data recorded on the optical disc 100 which is currently loaded in the optical disc reproducing apparatus 1, and the like. In the display example shown in FIG. 2, it is possible to recognize that the content data with a track number of 3 is currently reproduced, that 1 minute 15 seconds have elapsed since the reproduction start, and that the total track number of the content data recorded on the optical disc 100 which is loaded in the optical disc reproducing apparatus 1 is “16”.

The display device 50 wave-displays, in the middle part thereof a beat density of the content data along the reproduction time axis. Alternatively, it may wave-display signal intensity for each frequency band of the content data which is currently being reproduced.

The display device 50 displays, in the lower part thereof a playing address 51 including a pointer 52 which indicates the reproduction position at which the reproduction is currently being performed with respect to the reproduction time length of the entire content data which is currently a reproduction target. In the display example shown in FIG. 2, it is possible to recognize that the reproduction time length of the entire content data which is currently a reproduction target is 3 minutes, and that 1 minute 15 seconds have elapsed since the reproduction start (i.e. a data portion with a reproduction time of 1 minute 15 seconds is currently being reproduced).

The pointer 52 moves on the playing address 51, in accordance with the reproduction of the content data. For example, in the aforementioned forward reproduction, the pointer 52 movies from the left to the right in FIG. 2, in accordance with the reproduction of the content data. For example, in the aforementioned reverse reproduction, the pointer 52 movies from the right to the left in FIG. 2, in accordance with the reproduction of the content data. For example, in the aforementioned scratch reproduction, the pointer 52 moves to and fro between the right and the left in accordance with the operation amount of the jog dial 41.

Moreover, the pointer 52 further moves on the playing address 51 in accordance with the operation of the jog dial 41 when the start position is specified to start the reproduction of the content data from the desired position, in the quick search. Moreover, the elapsed track time changes in accordance with the operation of the jog dial 41 when the start position is specified to start the reproduction of the content data from the desired reproduction position. In other words, the pointer 52 and the elapsed track time show which reproduction position is specified on the reproduction time axis by the operation of the jog dial 41. As a result, the user can recognize the reproduction position specified by the operation of the jog dial 41, on the basis of the position of the pointer 52 and the display of the elapsed track time. If the reproduction position of interest is specified as the start position, the operation of the jog dial 41 is ended. On the other hand, if another reproduction position other than the reproduction position of interest is specified as the start position, the job dial 41 can be further operated so that the pointer 52 and the elapsed track time show the desired reproduction position.

Incidentally, in the aforementioned explanation, one portion of the configuration provided for the original DJ equipment or the like is extracted and described for simplification of explanation. Therefore, it is obvious that even an optical disc reproduction apparatus having another configuration other than that explained above is also included in the scope of the present invention. For example, it is obvious that it may be provided with a reproduction button for giving an instruction to start the reproduction of the content data, a stop button for giving an, instruction to stop the reproduction of the content data, a tempo button for instructing the reproduction speed of the content data, and other buttons.

(2) Explanation of Operation

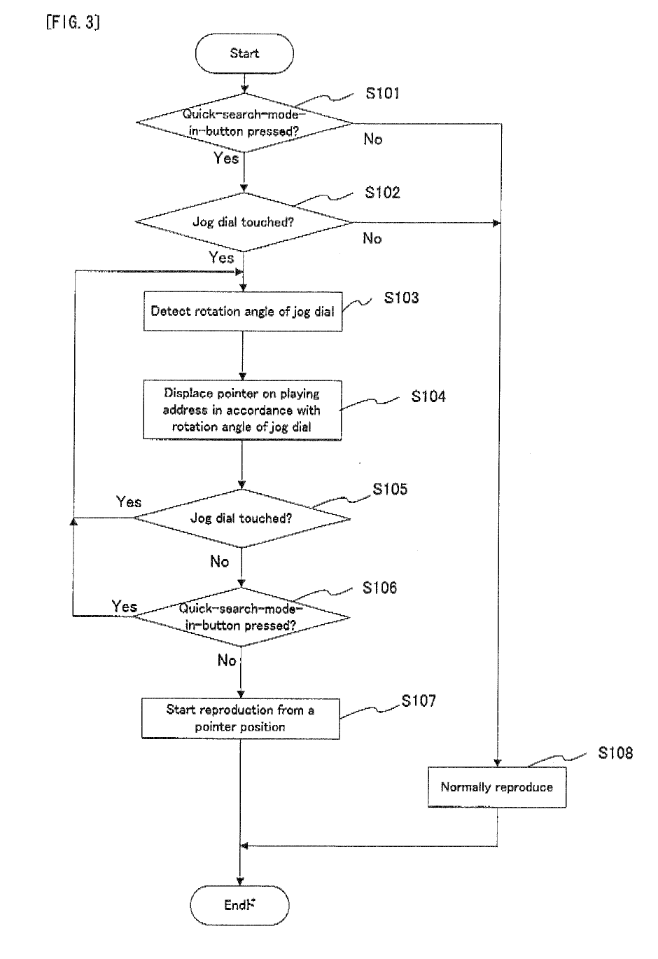

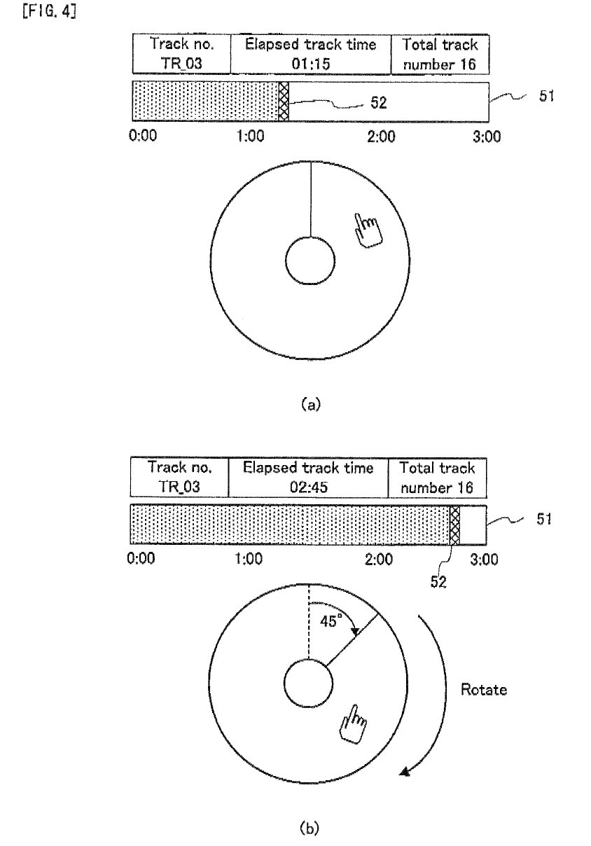

Next, with reference to FIG. 3 and FIG. 4, an explanation will be given on the operation principle of the optical disc reproducing apparatus 1 in the embodiment. FIG. 3 is a flowchart conceptually showing a flow of the operation of the optical disc reproducing apparatus 1 in the embodiment (particularly, a flow of the operation related to quick search). FIG. 4 are plan views conceptually showing a display aspect of the display device in quick search.

As shown in FIG. 3, firstly, it is judged whether or not the quick-search-mode-in-button 43 is pressed (step S101).

As a result of the judgment in the step S101, if it is judged that the quick-search-mode-in-button 43 is not pressed (the step S101: No), the quick search is not performed and the operation of the jog dial 41 by the user is regarded as an instruction to perform the forward reproduction, the reverse reproduction, and the scratch reproduction described above. That is, the content data is reproduced normally (step S108).

On the other hand, if it is judged that the quick-search-mode-in-button 43 is pressed (the step S101: Yes), then, it is judged whether or not the user is touching the jog dial 41 (step S102). In other words, it is judged whether or not the user is operating the jog dial 41. Incidentally, in the embodiment, the condition that “the jog dial 41 is operated” does not necessarily indicate that the jog dial 41 is rotated but merely indicates the condition that the user is touching the jog dial (specifically, the user is touching the jog dial 41 to the extent that a touch sensor mounted on the jog dial 41 senses the touch).

As a result of the judgment in the step S102, if it is judged that the user is not touching the jog dial 41 (the step S102: No), the content data is reproduced normally (step S108).

On the other hand, if it is judged that the user is touching the jog dial 41 (the step S102: Yes), the rotation angle of the jog dial 41 is detected by the operation of the angular velocity detection device 42 (step S103). Then, in accordance with the rotation angle of the jog dial 41, the pointer 52 on the playing address 51 is displaced (step S104). More specifically for example, it is assumed that 1-degree rotation of the jog dial 41 corresponds to a reproduction time of 2 seconds of the content data. In this case, for example, if the user rotates the jog dial 41 at 30 degrees in the clockwise direction, the pointer 52 is displayed in a position which is advanced by 2 seconds X 30=60 seconds from the current position on the playing address 51. Alternatively, for example, if the user rotates the jog dial 41 at 20 degrees in the counterclockwise direction, the pointer 52 is displayed in a position which goes back by 2 seconds×20=40 seconds from the current position on the playing address 51. Moreover, at this time, the display of the elapsed track time is also changed.

This operation of the jog dial 41 and the display aspect of the pointer 52 on the playing address 51 (moreover, the display aspect of the elapsed track time) will be explained in more details with reference to FIG. 4.

As shown in FIG. 4(a), it is assumed that the quick-search-mode-in-button 43 is pressed when 1 minute 15 seconds have elapsed since the reproduction start of the content data with a track number of 3 and that the Jog dial 41 is operated. While the jog dial 41 is operated, it is preferable that the reproduction of the content data is not advanced and that the reproduction signal is not outputted to the external output equipment through the external output terminal 19.

At this time, as shown in FIG. 4(b), it is assumed that the user rotates the jog dial 41 at 45 degrees in the clockwise direction. In this case, the pointer 52 is displayed in a position which is advanced by 2 seconds×45=90 seconds from the current position on the playing address 51. That is, the pointer 52 is displayed in a position corresponding to a reproduction time of 2 minute 45 seconds on the playing address 51. Moreover, the elapsed track time displayed in the upper part of the display device 50 displays 2 minute 45 seconds, in accordance with the operation of the jog dial 41.

At this time, the pointer 52 is preferably displayed such that it moves so as to flow from the left to the right, in accordance with the operation of the jog dial 41. That is, the pointer 52 is preferably displayed such that it moves linearly or in real time, in accordance with the operation of the jog dial 41.

In FIG. 3 again, it is judged whether or not the jog dial 41 is still operated (step S105).

As a result of the judgment in the step S105, if it is judged that the jog dial 41 is still operated (step S105: Yes), the user is judged to be still instructing the start position for starting the reproduction of the content data from the desired reproduction position (i.e. still performing the quick search). The operational flow returns to the step S103, and the operations in the step S103 and the step S104 describe above are repeated.

On the other hand, if it is judged that the jog dial 41 is not operated (i.e. that the user is not touching the jog dial 41) (step S105: No), then, it is judged whether or not the quick-search-mode-in-button 43 is still pressed (step S106).

As a result of the judgment in the step S106, if it is judged that the quick-search-mode-in-button 43 is still pressed (the step S106: Yes), the user is judged to be still instructing the start position for starting the reproduction of the content data from the desired reproduction position (i.e. still performing the quick search). The operational flow returns to the step S103, and the operations in the step S103 to the step S105 describe above are repeated.

On the other hand, if it is judged that the quick-search-mode-in-button 43 is not pressed (step S106: No), the reproduction of the content data is started from the start position specified by the operation of the jog dial 41 (i.e. the reproduction position indicated by the pointer 52) (step S107).

As explained above, according to the optical disc reproducing apparatus 1 in the embodiment, the content data can be reproduced from the desired reproduction position by using the jog dial 41. In particular, in accordance with the operation of the jog dial 41, the reproduction position of the content data (i.e. the reproduction position specified by the operation of the jog dial 41) is displayed, for example, as the pointer 52 on the display device 50. Thus, the user can recognize the reproduction position visually. As a result, after visually recognizing the reproduction position of the content data, the user can specify the desired reproduction position by using the jog dial 41. This allows the user to specify the desired reproduction position in the content data, directly and intuitively.

In addition, according to this embodiment, the quick search can be performed by using the jog dial 41 which is normally used for the forward reproduction, the reverse reproduction, and the scratch reproduction. In other words, the jog dial 41 can be shared for performing these search processes. Thus, the optical disc reproducing apparatus 1 is not necessarily newly equipped with an operation button for the quick search, so that the confirmation of the optical disc reproducing apparatus 1 can be made relatively simple. In addition, since the jog dial 41 that the user is used to operating is used for the quick search, a new function of the quick search can be added without an influence on the user's operability.

However, from the viewpoint that the desired reproduction position in the content data can be specified directly and intuitively, the jog dial (or operation key) for the forward reproduction, the reverse reproduction, and the scratch reproduction may be provided separately from and independently of the jog dial (or operation key) for the quick search.

Moreover, compared with the normal forward reproduction or the like, it is possible to quickly perform the reproduction of the content data from the desired reproduction position (so to say, to quickly search for the desired reproduction position in the content data). Thus, it is possible to quickly set the reproduction point of the content data to a certain point, to thereby reduce a time length related to the operation, resulting in the user's improved operability.

Moreover, according to the embodiment, the display device 50 wave-displays the beat density of the content data or the like, so that the user can find out a peak position (or most exciting position) of music or the like, relatively easily. Thus, the user can specify the peak position of music or the like as the start position, relatively easily. By this, for example, it is possible to select and reproduce an exciting point or a quite point of the music, depending on the circumstances that the content data is reproduced.

Incidentally, in the aforementioned embodiment, it is judged that the quick search is ended when the quick-search-mode-in-button 43 is not pressed, and then the reproduction of the content data is started. In other words, in order to perform the quick search, the quick-search-mode-in-button 43 needs to be always pressed. However, for example, it may be judged that the quick search is ended when the user releases the jog dial 41 (i.e. when the user ends the operation of the jog dial 41 and the touch sensor of the jog dial 41 does not sense the touch). That is, pressing the quick-search-mode-in-button 43 may be treated as a trigger to start the quick search, and the user's releasing the jog dial 41 may allow the reproduction of the content data to be started from the start position specified by the jog dial 41. By virtue of such construction, it is unnecessary to perform a complicate button operation to give an instruction to end the quick search, resulting in the user's improved operability.

Moreover, in order to start the reproduction of the content data from the start position specified by the jog dial 41, the quick-search-mode-in-button 43 may be pressed again (or changed to OFF).

Moreover, in the aforementioned embodiment, the quick-search-mode-in-button 43 is provided separately; however, in addition to or instead of providing the quick-search-mode-in-button 43 separately, the touch sensor of the jog dial 41 may realize the function of the quick-search-mode-in-button 43. For example, the quick search may be started when the jog dial 41 is pressed under a certain condition and the touch sensor outputs a predetermined signal. By virtue of such construction, the user can perform the quick search with one hand without operating the quick-search-mode-in-button 43 provided separately. Thus, the user can perform another reproduction process with the other free hand. This allows the user's operability to be improved and a wider variety of reproduction process to be realized.

Moreover, it is also obvious that the aspect of displaying the reproduction position of the content data is not limited to the specific example shown in FIG. 2. In other words, it is only necessary to change the display of the reproduction position in accordance with the reproduction of the content data or the operation of the jog dial 41.

(3) Modified Example

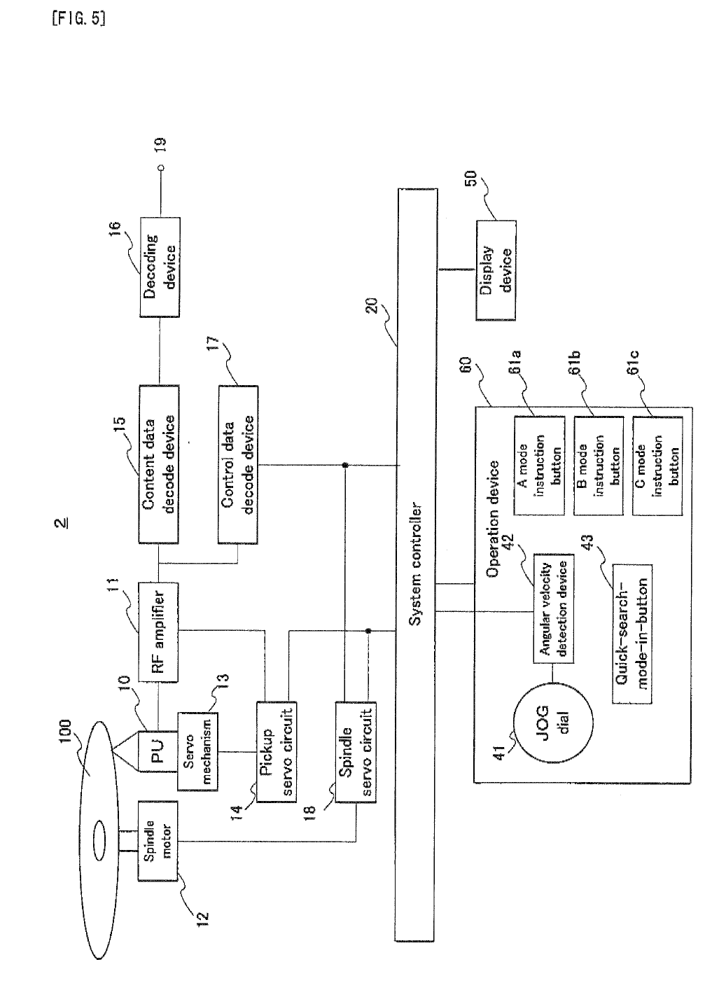

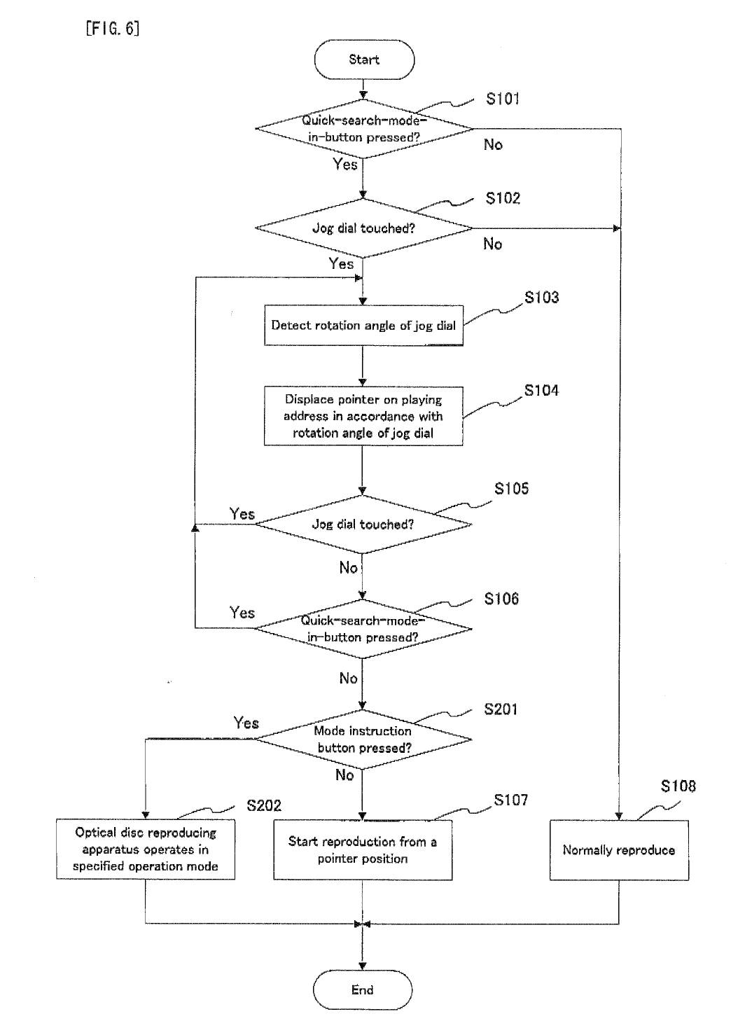

Next, with reference to FIG. 5 and FIG. 6, an explanation will be given on a modified example of the optical disc reproducing apparatus in the embodiment. FIG. 5 is a block diagram conceptually showing the basic structure of an optical disc reproducing apparatus 2 in a modified example. FIG. 6 is a flowchart conceptually showing a flow of the operation of the optical disc reproducing apparatus 2 in the modified example (particularly, a flow of the operation related to quick search). Incidentally, in the modified example, the same structure and operation as those of the aforementioned optical disc reproducing apparatus 1 carry the same numerical number or step number, and the detailed explanation thereof will be omitted.

As shown in FIG. 5, the optical disc reproducing apparatus 2 in the modified example, as in the aforementioned optical disc reproducing apparatus 1, is provided with: an optical pickup (PU) 10; a radio frequency (RF) amplifier ii; a spindle motor 12; a servo mechanism 13; a pickup servo circuit 14; a content-data decode device 15; a decoding device 16; a control-data decode device 17; a spindle servo circuit 18; an external output terminal 19; a system controller 20; and a display device 50.

In particular, the optical disc reproducing apparatus 2 in the modified example is provide with an operation device 60 which has: a jog dial 41; an angular velocity detection device 42; a quick-search-mode-in-button 43; an A mode instruction button 61a; a B mode instruction button 61b; and a C mode instruction button 61c.

Each of the A mode instruction button 61a, the B mode instruction button 61b, and the C mode instruction button 61c constitutes one specific example of the “specifying device” of the present invention, and each of them is a button for instructing an operation aspect of the optical disc reproducing apparatus 1 after the quick search ends. For example, if any of the A mode instruction button 61a, the B mode instruction button 61b, and the C mode instruction button 61c is pressed during the quick search, the optical disc reproducing apparatus 1 operates in an aspect according to the pressed mode instruction button after the quick search ends.

For example, if the A mode instruction button 81a is pressed, the optical disc reproducing apparatus 1 may operate such that the reproduction is stopped for a predetermined time (i.e. a predetermined time of pause) after the quick search ends and that the desired content data is reproduced from the start position specified by the operation of the jog dial 41. Alternatively, if the B mode instruction button 61b is pressed, the optical disc reproducing apparatus 1 operates such that the desired content data is reproduced from the start position specified by the operation of the jog dial 41 in the reproduction aspect set by the user after the quick search ends. In case of the C mode instruction button 61c, the optical disc reproducing apparatus 1 may stand by (or pause) at the specified position after the quick search ends. In this case, the deactivation of the pause (i.e. the reproduction) may be performed by pressing the mode instruction button or other buttons, or by some operation of the jog dial 41 or the like.

Next, an explanation will be given on a flow of the operation of the optical disc reproducing apparatus 2 in the modified example. As shown in FIG. 6, as in the aforementioned optical disc reproducing apparatus 1, the optical disc reproducing apparatus 2 in the modified example performs the operations from the step S101 to the step S106.

In particular, in the case of the optical disc reproducing apparatus 2 in the modified example, in the judgment in the step S106, if it is judged that the quick-search-mode-in-button 43 is not pressed (the step S106: No), then, it is judged whether or not any of the A mode instruction button 61a, the B mode instruction button 61b, and the C mode instruction button 61c is pressed or has been pressed (step S201).

As a result of the judgment in the step S201, if it is judged that none of the A mode instruction button 61a, the B mode instruction button 61b, and the C mode instruction button 61c is pressed or has been pressed (the step S201: No), the reproduction of the content data is started from the start position specified by the operation of the jog dial 41 (i.e. the reproduction position shown by the pointer 52) (step S107).

On the other hand, if it is judged that any of the A mode instruction button 61a, the B mode instruction button 61b, and the C mode instruction button 61c is pressed or has been pressed (the step S201: Yes), the optical disc reproducing apparatus 1 operates in the operation mode according to the pressed mode instruction button, as described above (step S202).

As described above, according to the optical disc reproducing apparatus 2 in the modified example, it is possible to arbitrarily change the operation aspect of the optical disc reproducing apparatus 1 after the quick search ends. Therefore, the reproduction or the like of the content data can be performed in a wider variety of aspects.

The present invention is not limited to the aforementioned embodiment, and various changes may be made without departing from the essence or spirit of the invention which can be read from the claims and the entire specification. An information reproducing apparatus and method, DJ equipment, and a computer program, which involve such changes, are also intended to be within the technical scope of the present invention.

### INDUSTRIAL APPLICABILITY

The information reproducing apparatus and method, the DJ equipment, and the computer program according to the present invention can be applied to DJ equipment and an information reproducing apparatus for reproducing audio information and video information recorded on a recording medium, such as a CD and a DV). Moreover, they can be applied to the DJ equipment and the information reproducing apparatus, or the like which is mounted on various computer equipment for consumer use or for commercial use, or which can be connected to various computer equipment.

1-11. (canceled)

12. An information reproducing apparatus comprising:
a reproducing device for reproducing content data;
an operating device which is movable by an operation of a user and which is used in realizing each of a first function and a second function, the first function being for adding a predetermined effect to the reproduction of the content data, the second function being for specifying a start position for start the reproduction of the content data from an arbitrary position;
a changing device for changing whether to rate the first function or the second function on said operating device;
a reproduction controlling device for making said reproducing device reproduce the content data from the start position specified by said operating device; and
an elapsed amount of a reproduction time of the content data, which is defined by an operation amount of said operating device, in a case that the second function is realized is greater than an elapsed amount of a reproduction time of the content data, which is defined by an operation amount of said operating device, in a case that the first function is realized.

13. The information reproducing apparatus according to claim 12, wherein said reproduction controlling device makes said reproducing device reproduce the content data from the start position specified by said operating device after the operation of said operating device by the user is ended.

14. The information reproducing apparatus according to claim 12, further comprising a specifying device for specifying an operation mode of the content data after the operation of said operating device by the user is ended,
said reproduction controlling device controlling the operation of said reproducing device in the operation mode specified by said specifying device.

15. The information reproducing apparatus according to claim 12, further comprising a detecting device for detecting the end of the operation of said operating device by the user to realize the second function,
said changing device performing automatic change such that the first function is realized on said operating device if the end of the operation of said operating device to realize the second function is detected by said detecting device.

16. The information reproducing apparatus according to claim 12, further comprising a displaying device for displaying reproduction-position information of the content data.

17. The information reproducing apparatus according to claim 16, wherein said displaying device displays the reproduction-position information according to the operation of said operating device if the second function is realized on said operating device.

18. The information reproducing apparatus according to claim 12, wherein said operating device rotates in accordance with the operation of the user.

19. An information reproducing method in an information reproducing apparatus comprising: a reproducing device for reproducing content data; and an operating device which is movable by an operation of a user and which is used in realizing each of a first function and a second function, the first function being for adding a predetermined effect to the reproduction of the content data, the second function being for specifying a start position for start the reproduction of the content data from an arbitrary position, said information reproducing method comprising:
a changing process of changing whether to realize the first function or the second function on said operating device;
a reproduction controlling process of making said reproducing device reproduce the content data from the start position specified by said operating device; and
an elapsed amount of a reproduction time of the content data, which is defined by an operation amount of said operating device, in a case that the second function is realized is greater than an elapsed amount of a reproduction time of the content data, which is defined by an operation amount of said operating device, in a case that the first function is realized.

20. A DJ equipment comprising:
a reproducing device for reproducing content data;
an operating device which is movable by an operation of a user and which is used in realizing each of a first function and a second function, the first function being for adding a predetermined effect to the reproduction of the content data, the second function being for specifying a start position for start the reproduction of the content data from an arbitrary position;
a reproduction controlling device for making said reproducing device reproduce the content data from the start position specified by said operating device; and
an elapsed amount of a reproduction time of the content data, which is defined by an operation amount of said operating device, in a case that the second function is realized is greater than an elapsed amount of a reproduction time of the content data, which is defined by an operation amount of said operating device, in a case that the first function is realized.

21. The DJ equipment according to claim 8, further comprising a changing device for changing whether to realize the first function or the second function on said operating device.

22. A computer program product in a computer-readable medium for tangibly embodying a program of instructions executable by a computer provided in an information reproducing apparatus, the computer program making the computer function as at least one portion of the information reproducing apparatus, the information reproducing apparatus comprising:
a reproducing device for reproducing content data;
an operating device which is movable by an operation of a user and which is used in realizing each of a first function and a second function, the first function being for adding a predetermined effect to the reproduction of the content data, the second function being for specifying a start position for start of the production of the content data from an arbitrary position;
a changing device for changing whether to realize the first function or the second function on said operating device;
a reproduction controlling device for making said reproducing device reproduce the content data from the start position specified by said operating device; and
an elapsed amount of a reproduction time of the content data, which is defined by an operation amount of said operating device, in a case that the second function is realized is greater than an elapsed amount of a reproduction time of the content data, which is defined by an operation amount of said operating device, in a case that the first function is realized.
